(19) United States
(12) Patent Application Publication
(10) Pub. No.: US 2016/0096045 A1
(43) Pub. Date: Apr. 7, 2016

(54) STEP UNIT WITH FALL ARREST CAPABILITY

(71) Applicant: Glenn Sailer, Escondido, CA (US)

(72) Inventor: Glenn Sailer, Escondido, CA (US)

(21) Appl. No.: 14/811,672

(22) Filed: Jul. 28, 2015

Related U.S. Application Data
(60) Provisional application No. 62/059,148, filed on Oct. 2, 2014.

(51) Int. Cl. A62B 35/00

(52) U.S. Cl. CPC A62B 35/0068

(57) ABSTRACT

A step unit with fall arrest capability is provided for use in climbing a utility structure. The step unit includes a bolt member having a shape of substantially an elongated solid cylinder and a fall arrest member integrally attached to the bolt member. The bolt member includes: a head section formed at one end portion; a thread section formed at the other end portion; and a shank section formed contiguous to the head section. The fall arrest member includes: a flange section integrally attached between the shank section and the thread section; and a loop section, one end portion of which is integrally attached to the flange section and the other end portion of which is integrally attached to the shank section, providing an opening for use as an anchorage of a fall arrest system.

### CROSS REFERENCE

This U.S. patent application claims the benefit of U.S. provisional patent application Ser. No. 62/059,148, filed on Oct. 2, 2014.

### BACKGROUND

The present invention broadly relates to safety equipment for climbing utility structures, such as utility towers and utility poles.

Fall arrest is one form of fall protection, regulations of which are specified by OSHA to prevent individuals working at height from fall injury. Personal fall arrest is one type of fall arrest, and a personal fall arrest system typically includes at least the following four key elements: anchorage, body wear, connector, and deceleration device. An anchorage is a secure point, often referred to as a tie-off point, for attachment to a structural part such as a rebar, I-beam, scaffolding and the like. A body wear is typically a body harness worn by the worker. A deceleration device has a mechanism to dissipate a substantial amount of energy and force associated with a fall arrest event. Examples of deceleration device include a rope grab, shock-absorbing lanyard, fall limiter, self-retracting lifeline and the like, one end of which can be coupled to a body wear. A connector is a device used to couple the other end of the deceleration device to the anchorage, such as a cross-arm strap, beam anchor, snap-hook, carabiner and the like. Each of these parts of a personal fall arrest system is typically required to sustain a minimum of 5,000 pounds per worker.

A utility tower is typically constructed to have threaded holes, which are to be engaged with threaded step rungs. Such a step rung is typically formed to have a shape of a bolt, i.e., an elongated solid cylinder with a threaded end portion, which is fastened with a nut to secure the engagement with the threaded hole. A utility pole is typically constructed to have holes where step rungs are to be inserted. The end portion of such a step rung may include a hook or be properly shaped for securing the step rung through the hole.

Utility workers climb utility structures, such as utility towers and utility poles, for repair, construction, maintenance and other purposes, with a variety of safety equipment. Conventional techniques addressing fall arrest in climbing a utility tower or pole include use of an independent component, such as a carabiner, climbing clip, hook and the like, to couple the deceleration device to the step rung installed with the structure. Other examples include a step rung integrated with an attachment to allow the climber to hook in a hook or clip installed at the end of the deceleration device, or to weave a climbing cable or rope around the step rung. However, these conventional techniques often fail to meet the requirement of supporting a load of 5,000 pounds or greater per worker. Therefore, there is a need for an easily installable step rung with reliable fall arrest capability. Furthermore, while new constructions of utility structures can be configured with safety equipment installed at the onset of construction, it is often necessary to retrofit old utility structures with new safety equipment to meet increasingly stringent safety requirements.

### BRIEF DESCRIPTION OF THE DRAWINGS

FIGS. 1-4 illustrate a perspective view, a front view, a top view and a side view, respectively, of a step unit with fall arrest capability according to an embodiment.

FIG. 5 illustrates an example of configuration of the step unit installed with a utility structure.

### DETAILED DESCRIPTION

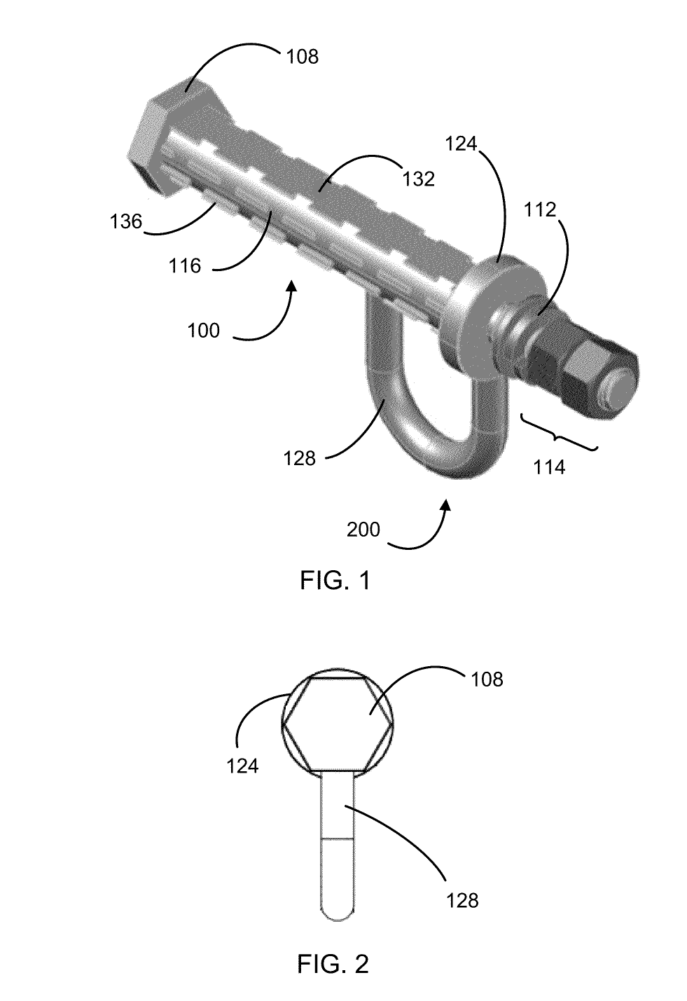

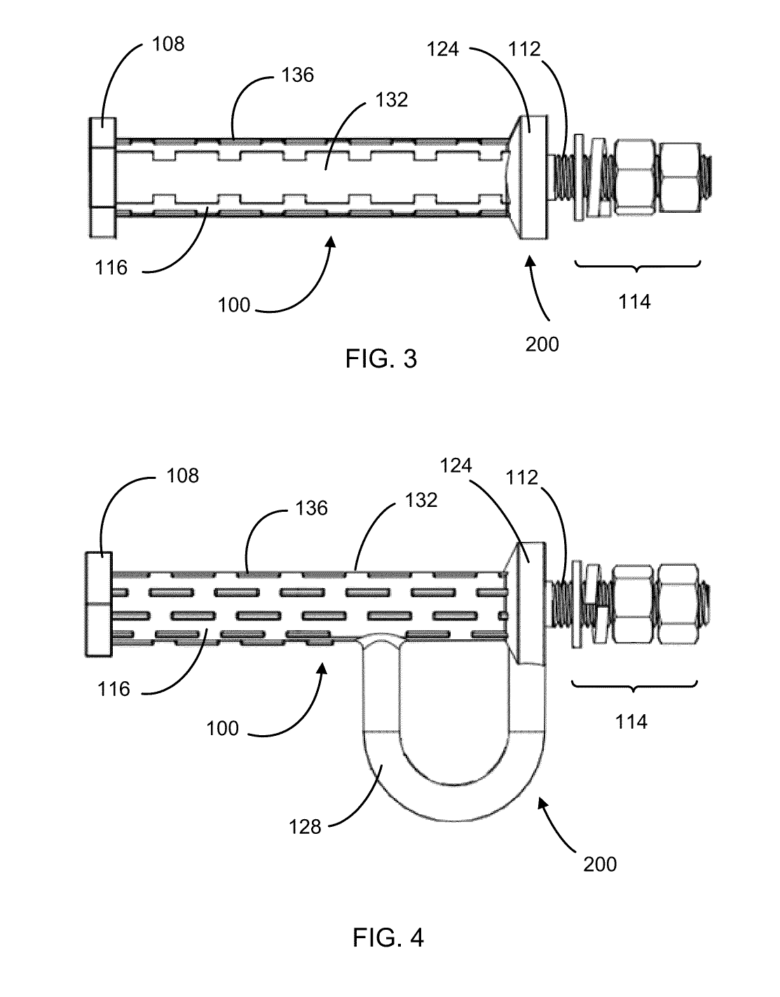

FIGS. 1-4 illustrate a perspective view, a front view, a top view and a side view, respectively, of a step unit with fall arrest capability for use in climbing a utility structure, such as a utility tower or a utility pole, according to an embodiment. The present step unit includes two main members: a bolt member 100 and a fall arrest member 200, which are integrally attached to provide one solid piece of equipment. The bolt member 100 has a shape of substantially an elongated solid cylinder. The fall arrest member 200 is configured for use as an anchorage of a fall arrest system. The bolt member 100 includes a head section 108 formed at one end portion. The head section 108 has a cross-sectional shape along the transversal direction, which is orthogonal to the longitudinal direction of the bolt member 100. The cross-sectional shape of the head section 108 may be a hexagon, a square, a rectangle, an oval, a circle or any other shape as long as it helps a wrenching drive to screw the bolt member 100 into the utility structure. The other end portion of the bolt member 100 has a threaded surface, providing a thread section 112. The thread section 112 is configured to have a length sufficient to penetrate through a hole formed in the utility structure, so that the bolt member 100 can be secured through the hole of the utility structure, with the end portion of the thread section 112 protruding from the hole to the opposite side of the utility structure. The step unit in the example illustrated in FIGS. 1-4 is provided with fastening parts 114 as assembly parts. In FIGS. 3 and 4, the fastening parts 114, collectively called a fastener herein, are illustrated to include two nuts, one ring washer and one spring washer to provide various fastening options depending on the fastening strength needed for each use. For example, one nut may be used to fasten the thread section 112 to the utility structure. In another example, the spring washer and two nuts may be used for enhanced strength. Yet in another example, no washers or nuts may be used if only the threading provides enough fastening strength. The bolt member 100 has a shank section 116 contiguous to the head section 108, wherein the shank section 116 is configured to have a length sufficient for a foot of a climbing worker to step on. That is, the length of the shank section 116 is configured to be large enough to accommodate the width of the shoe the worker is wearing. The transversal dimension of the head section 108 is configured to be larger than that of the shank section 116, so as to prevent a foot of the worker from sideway slippage.

The fall arrest member 200 of the present step unit includes a flange section 124 and a loop section 128. The flange section 124 is integrally attached around the circumference of the bolt member 100 between the thread section 112 and the shank section 116. The loop section 128 has a shape of generally an open loop. One end portion of the loop section 126 is integrally connected to the flange section 124, while the other end portion of the loop section 128 is integrally connected to the shank section 116, thereby providing an opening defined by the loop section 128 and the part of the shank section 116 between the two end portions of the loop section 128, resembling a letter D in this example. Thus, the loop section 128 is configured for use as an anchorage of a fall arrest system in the present step unit.

The shank section 116 has a first surface and a second surface. The first surface includes a flat surface 132 that is formed opposite to the loop section 128, and extends longitudinally between the head section 108 and the flange section 124. When the present step unit is installed with the utility structure, the flat surface 132 can be oriented to face toward substantially the ascending direction to provide a flat standing platform for the worker. The second surface of the shank section 116 has multiple ridges 136 formed in a pattern between the head section 108 and the flange section 124. Each of the multiple ridges 136 is formed longitudinally along the length of the bolt member 100. The height, width and length of each ridge 136 as well as the pattern of the multiple ridges 136 can be configured to provide suitable friction to a vertical force exerted by a gripping hand or a slipping foot, thereby providing enhanced prevention from fall.

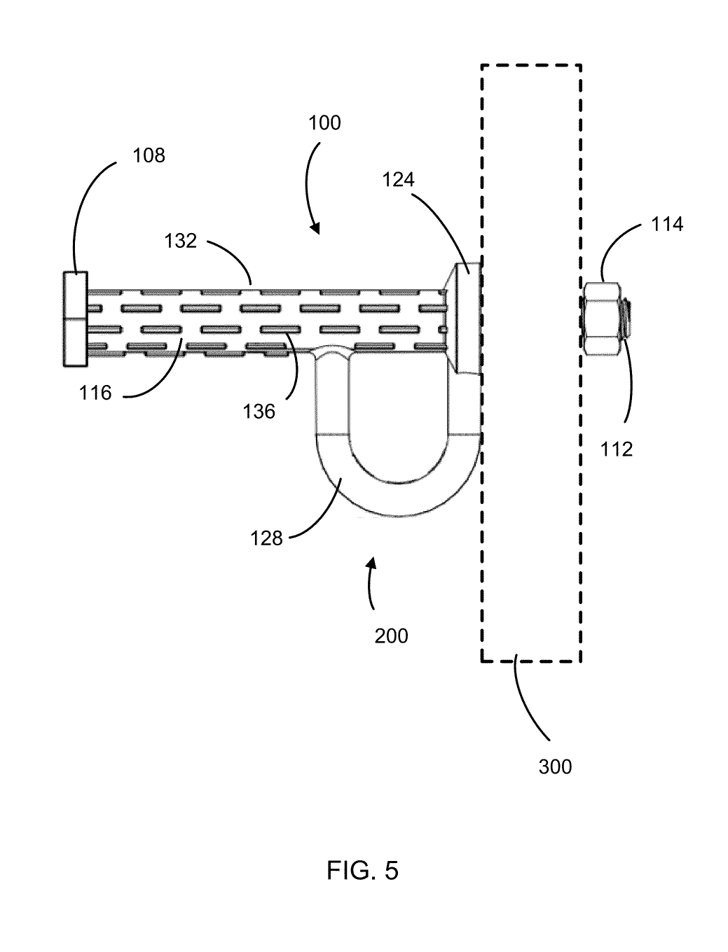

FIG. 5 illustrates an example of configuration of the present step unit installed with as utility structure 300. A portion of the utility structure 300 around a hole (not shown) formed therein is illustrated with dashed lines in FIG. 5. The pitch of the thread section 112 of the step unit may be configured to correspond to the pitch of the thread formed on the internal surface of the hole. Alternatively, the thread section 112 may be configured to engage with the internal surface of the hole as it is being screwed in through the hole without a thread if the utility structure is made of a soft material. A wrench, a hand, a motor or other suitable means can be applied to the head section 108 to drive the screwing-in motion of the step unit. The thread section 112 is screwed in to penetrate through the hole until the flange section 124 gets flush against the side of the utility structure, and one nut 114 is used in this example to fasten the end portion of the thread section 112 protruding from the hole to the opposite side of the utility structure. In this configuration, the loop section 128 is positioned to point toward the direction substantially opposite to the ascending direction, and the flat surface 132 is oriented to face toward substantially the ascending direction. As mentioned earlier, a deceleration device has a mechanism to dissipate a substantial amount of energy and force associated with a fall arrest event. Examples of deceleration device include a rope grab, shock-absorbing lanyard, fall limiter, self-retracting lifeline and the like, one end of which can be coupled to a body harness the worker is wearing. The other end of the deceleration device may include a connector, such as a cross-arm strap, beam anchor, snap-hook, carabiner and the like, which can be used for engagement with the loop section 128 of the fall arrest member 200 of the present step unit. The load testing is typically conducted to ensure the sustainability of a minimum of 5,000 pounds.

As illustrated in FIGS. 1-5, the fall arrest member 200 of the present step unit is integrally attached at one end portion of the shank section 116, which is the root portion of the step unit when installed with the utility structure 300. The fall arrest member 200 is provided at the root portion because the torque exerted by the load to the step unit is smaller when the fall arrest member 200 is at the root portion than when it is at the other end portion close to the head section 108, thereby providing better durability and strength.

The step unit may be made of cast alloy steel, for example. Various sections in the present step unit, except for the fastening parts 114, may be integrally formed by welding, molding, or other suitable processing technique.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting, in certain combinations and even initially claimed as such, one or more features from a claimed combination can in some cases be exercised from the combination, and the claimed combination may be directed to a subcombination or a variation of a subcombination.

What is claimed is:

1. A step unit with fall arrest capability for use in climbing a utility structure, the step comprising:
a bolt member having a shape of substantially an elongated solid cylinder, the bolt member comprising:
a head section formed at one end portion for use for wrenching;
a thread section formed at the other end portion and having a threaded surface with a length sufficient to penetrate through a hole formed in the utility structure; and
a shank section formed contiguous to the head section,
and
a fall arrest member comprising:
a flange section integrally attached between the shank section and the thread section; and
a loop section, one end portion of which is integrally attached to the flange section and the other end portion of which is integrally attached to the shank section, providing an opening defined by the loop section and a part of the shank section between the two end portions of the loop section.

2. The step unit of claim 1, wherein
the shank section has a first surface including a flat surface that is formed opposite to the loop section, and extends longitudinally between the head section and the flange section, to provide a flat standing platform for a worker climbing the utility structure.

3. The step unit of claim 1, wherein
the shank section has a second surface including a plurality of ridges longitudinally formed in a pattern, wherein height, width and length of each ridge and the pattern are configured to provide friction to a vertical force exerted by a gripping hand or a slipping foot of a worker climbing the utility structure.

4. The step unit of claim 1, wherein
the thread section is configured to be screwed in to penetrate through the hole to have the flange section flush against a side of the utility structure,
a fastener is used to fasten an end portion of the thread section protruding from the hole to the opposite side of the utility structure, and
the loop section is configured to be positioned to point toward a direction substantially opposite to an ascending direction, while the flat surface is oriented to face toward substantially the ascending direction,
for installing the step unit with the utility structure.
